(19) United States
(12) Patent Application Publication
(10) Pub. No.: US 2006/0233978 A1
(43) Pub. Date: Oct. 19, 2006

(54) Skeleton structural member transportation equipment and method of manufacturing the same

(75) Inventor: Shouzi Yamazaki, Wako-shi (JP)

Correspondence Address: RANKIN, HILL, PORTER & CLARK LLP, 4080 ERIE STREET, WILLOUGHBY, OH, 44094-7836, US

(73) Assignee: HONDA MOTOR CO., LTD., TOKYO (JP)

(21) Appl. No.: 10/562,582

(22) PCT Filed: Jun. 23, 2004
(86) PCT No.: PCT/JP04/09213

§ 371 Date: Dec. 28, 2005

(30) Foreign Application Priority Data
Jul. 1, 2003 (JP) 2003-189771

(51) Int. Cl. B31B 45/00

(52) U.S. Cl. 428/34.1

(57) ABSTRACT

A skeleton structure member made by disposing a solidified granular bulk material obtained by bonding together and thereby solidifying multiple granules inside a skeleton member of a transport machine and/or a space bounded by a skeleton member and a panel member peripheral thereto. In the solidified granular bulk material, the granules are bonded together by surface fusion and an internal pressure is created by expansion.

### TECHNICAL FIELD

The present invention relates to a skeleton structure member for use in a transport machine such as a railroad car, an industrial vehicle, a ship, an aircraft, an automobile or a motorcycle, and to a manufacturing method thereof

### BACKGROUND ART

Skeleton structure members made by filling a skeleton member with a granular bulk material are known from for example JP-A-2002-193649, U.S. Pat. No. 4,610,836 and U.S. Pat. No. 4,695,343.

Reference is now made to FIG. 16 showing a solidified granular bulk material of a skeleton structure member disclosed in JP-A-2002-193649.

This solidified granular bulk material 200 is made up of granules 201 and a resin or adhesive binder 202 filled between these granules 201 to make the granules 201 into a solid, and is formed by the granules 201 being packed in a structurally dense way and the binder 202 being poured in after that. This solidified granular bulk material 200 is inserted into a skeleton member of a vehicle body or the like to make a skeleton structure member, and the strength and rigidity of the vehicle body is thereby raised.

Next, reference is made to FIG. 17 showing a solidified granular bulk material of a skeleton structure member described in U.S. Pat. No. 4,610,836 and U.S. Pat. No. 4,695,343.

This solidified granular bulk material 210 is made up of small glass spheres 212 serving as granules coated with an adhesive 211. These glass spheres 212 are wrapped with a cloth made of glass fiber and packed into a skeleton member to make a skeleton structure member.

However, in the solidified granular bulk material 200 shown in FIG. 16, compared to the case of the granules 201 only, the weight is greater by an amount corresponding to the binder 202. And similarly also in the case of the solidified granular bulk material 210 shown in FIG. 17, compared to the case of the small spheres 212 only, the weight is greater by an amount corresponding to the adhesive 211. Consequently, the increase in weight of skeleton structure members in which these solidified granular bulk materials 200, 210 are used is large.

Although if the granules 201 or the small spheres 212 are packed densely the rigidity of the solidified granular bulk material 200, 210 is increased, to pack the granules 201 or the small spheres 212 into a closed space it is necessary to devise means for applying pressure to them from outside, and it is not easy.

Next, the absorbed energies of skeleton structure members in which the above-mentioned solidified granular bulk materials 200, 210 have been used will be obtained by forcibly bending the skeleton structure members in a bending test.

Reference is now made to FIG. 18 showing a method of a skeleton structure member bending test. The bending test is carried out by supporting a skeleton structure member 220 on two support points 221, 221 and applying a downward load F to the upper face of the skeleton structure member 220 at a central position between the support points 221, 221 via a pushing piece 222 of the bending test apparatus. The symbol δ is the stroke, i.e. the downward displacement, of the pushing piece 222. The reference number 223 denotes a solidified granular bulk material inserted into the skeleton structure member 220.

Next, reference is made to FIG. 19 showing in simplified form a relationship between load and displacement obtained as the result of a bending test on a skeleton structure member. The vertical axis shows the load F and the horizontal axis the displacement δ.

In this graph, while the displacement δ is small, the load F rises sharply in a straight line, and then the increasing of the load F gradually slows and a maximum load f1 is reached, after which as the displacement δ increases the load F gradually decreases and eventually becomes roughly constant.

If the load at the upper end of the straight part of the rise is written L and the angle of the straight line is written α, then the greater is the angle α and the greater is the load L (i.e. the longer is the straight line), the greater is the rigidity of the skeleton structure member. Also, the greater is the load f1 the stronger is the skeleton structure member.

The area of the part sandwiched between the line of this graph and the horizontal axis is the work done, i.e. the energy absorbed by the deformation of the skeleton structure member, and-for example is used to obtain the energy absorbed by the skeleton structure of a vehicle during a crash.

FIG. 20A through FIG. 20D are graphs showing relationships between load and displacement, and absorbed energies, obtained as the results of bending tests on skeleton structure members.

Sample 1 in the graph shown in FIG. 20A is the same member as the skeleton structure member shown in FIG. 19, and is a skeleton structure member having for example a hollow square cross-section and not having a solidified granular bulk material inserted into it.

With Sample 2, the load F is greater than in the case of Sample 1 at displacements greater than the displacement of Sample 1 corresponding to the maximum load f1.

With Sample 3, the load F is greater than in the case of Sample 2 at displacements greater than the displacement of Sample 1 corresponding to the maximum load f1.

The absorbed energies of Samples 1 to Sample 3 are shown in FIG. 20B.

In FIG. 20B, the vertical axis shows absorbed energy E. If the absorbed energies of Sample 1 to Sample 3 are written e1 to e3, then e1<e2<e3.

In FIG. 20C, Sample 4 is a member having a greater angle α of rise (see FIG. 19) than in the case of Sample 1 and having a load f2 greater than the load f1 of Sample 1 as its maximum value, and at displacements δ greater than the displacement at the load f2 it gradually comes to overlie Sample 1.

Sample 5 is a member having a greater angle a of rise (see FIG. 19) than in the case of Sample 4 and having a load f3 greater than the load f2 of Sample 4 as its maximum value, and at displacements δ greater than the displacement at the load f3 it gradually comes to overlie Sample 1.

The absorbed energies of Sample 1, Sample 4 and Sample 5 are shown in FIG. 20D.

In FIG. 20D, the vertical axis shows the absorbed energy E. If the absorbed energies of Sample 4 and Sample 5 are written e4 and e5, then e1<e4<e5.

From FIG. 20A to FIG. 20D it can be seen that, although the increase in absorbed energy resulting from just the maximum value of the load F increasing is small, if the maximum value of the load F is increased and also the load after the maximum load occurs is kept high, the increase in absorbed energy can be made large.

FIG. 21 shows a state of deformation of a skeleton structure member of related art in a bending test.

For example when a skeleton structure member 205 with a solidified granular bulk material 200 (see also FIG. 16) inserted into it is deformed in a bending test, the part where the solidified granular bulk material 200 was inserted barely deforms at all, and the parts beyond the ends of the solidified granular bulk material 200 deform greatly. The reference number 206 denotes a bent part of a skeleton member 207 greatly deformed and bent.

This appears to be a result of the strength of the part where the solidified granular bulk material 200 is inserted being very high, due to strong bonding of the densely packed granules and the binder, and strain concentrating at parts where the solidified granular bulk material 200 is not present.

FIG. 22 is a graph of bending tests on skeleton members shown as Comparison Examples 1 to 3, in which the vertical axis shows the load F and the horizontal axis the displacement δ. The maximum displacement δ in the data of each case is the value immediately before the load F falls sharply as the displacement δ gradually increases.

Comparison Example 1, shown with a dashed line, is a skeleton structure member having a hollow square cross-section and no solidified granular bulk material inserted, and although the maximum displacement d5 is large, the maximum load f5 is small.

Comparison Example 2, shown with a singly dotted line, is the skeleton structure member shown in FIG. 16 and FIG. 21, that is, having a solidified granular bulk material made by bonding solid granules with a binder, and although since the bonding of the granules is strong the maximum load f6 is large, as a result of the parts where the solidified granular bulk material is not present undergoing great local deformation in the early stage of the bending test, the maximum displacement d6 is small.

Comparison Example 3, shown with a doubly dotted line, is the skeleton structure member shown in FIG. 17, that is, having a solidified granular bulk material made by coating and bonding solid granules with an adhesive, and although since the bonding of the granules is strong the maximum load f7 is larger than in Comparison Example 2, because local deformation is large as in the case of Comparison Example 2, the maximum displacement d7 is small.

FIG. 23 shows the absorbed energies of the skeleton structure members shown in FIG. 22 (Comparison Example 1 to Comparison Example 3). The vertical axis shows absorbed energy E.

When the absorbed energy of Comparison Example 1 is taken as 1.0, that of the Comparison Example 2 is lower than that of Comparison Example 1, and that of Comparison Example 3 takes a value approximately the same as Comparison Example 1.

Thus, in Comparison Example 2 and Comparison Example 3, because the granules are bonded strongly the strength of the part of the skeleton structure member packed with the granules becomes excessively high and in the early stage of the bending test local breaking occurs and the load sharply falls, and consequently the absorbed energy is no more than in Comparison Example 1.

Accordingly, a skeleton structure member for use in a transport machine and a method for manufacturing this skeleton structure member have been awaited with which it is possible to suppress weight increase accompanying solidification of the granular bulk material and to pack the granular bulk material into the skeleton member easily, and furthermore with which the absorbed energy of the skeleton structure member is increased.

### DISCLOSURE OF THE INVENTION

According to an aspect of the present invention, there is provided a skeleton structure member for use in a transport machine having disposed in a skeleton member of a transport machine and/or a space surrounded by a skeleton member and a panel member peripheral to it a solidified granular bulk material made by bonding together and thereby solidifying multiple granules, wherein in the solidified granular bulk material the granules are bonded together by surface fusion and an internal pressure is created by expansion.

Because the granules are bonded together by surface fusion like this, a binder of adhesive or resin or the like for bonding the granules together is not necessary, and weight increase accompanying solidification can be kept down. And, because an internal pressure is created by expansion of the granules, packing under pressure is not necessary, and the granules can be packed into the skeleton member or space easily. Also, when a load acts from outside on the solidified granular bulk material, the superficial fused parts of the hitherto solidified granules detach and the granules become single and assume fluidity, and strain arising due to the load from outside is distributed and concentrating of the strain can be prevented. Therefore, it is possible for the skeleton structure member to be deformed approximately uniformly and up to a large displacement. At this time, because inward deformation of the skeleton member walls can be suppressed by the above-mentioned internal pressure, a large load can be supported up to a large displacement, and compared to related art it is possible to increase the absorbed energy of the skeleton structure member.

The invention also provides a method for manufacturing a skeleton structure member for use in a transport machine having disposed in a skeleton member of a transport machine and/or a space surrounded by a skeleton member and a panel member peripheral to it a solidified granular bulk material made by bonding together and thereby solidifying multiple granules, including a step of placing granules made by wrapping a core substance consisting of a liquid or a solid with a film into a skeleton member and/or a space and a step of causing the granules to expand by heating them.

As a result of the core substance being gasified by the granules being heated to expand them, the granules constituting the solidified granular bulk material become hollow and the weight increase accompanying solidification can be suppressed. And, because an internal pressure is created in the skeleton member or space by the granules expanding, it is not necessary for the granules to be packed under pressure and the granules can be placed into the skeleton member or into the space easily. Also, when a load from outside acts on the solidified granular bulk material, more so than when solid granules are used, the strength of the solidified granular bulk material does not become excessively high, and furthermore under the load acting from outside the granules constituting the solidified granular bulk material gradually come to flow while deforming, and the strain arising from the load from outside is distributed and concentrating of the strain can be prevented. Therefore, the strength of the solidified granular bulk material does not change suddenly, a large load can be supported up to a large displacement, and compared to related art it is possible to increase the energy absorbed by the skeleton structure member.

### BRIEF DESCRIPTION OF THE DRAWINGS

FIG. 1 is a perspective view of a skeleton structure member for use in a transport machine according to the invention;

FIG. 2 is a sectional view of the skeleton structure member on the line 2-2 in FIG. 1;

FIG. 3 is a sectional view of the skeleton structure member on the line 3-3in FIG. 1;

FIG. 4 is a sectional view showing the bonding state of a solidified granular bulk material according to the invention;

FIG. 5 is an action view showing a change of a granule according to the invention;

FIG. 6 is an action view showing a manufacturing method of a skeleton structure member according to the invention;

FIG. 7A is a view showing the state of a skeleton structure member according to an embodiment after a bending test is carried out on it;

FIG. 7B is a view showing the state of a skeleton structure member according to a comparison example after a bending test is carried out on it;

FIG. 7C(a) is a view showing strain arising during the bending test of the skeleton structure member according to an embodiment;

FIG. 7C(b) is a view showing strain arising during the bending test of the skeleton structure member according to the comparison example;

FIG. 8A to FIG. 8C are views showing deformation states of a skeleton structure member according to the invention in a bending test;

FIG. 9 is a sectional view showing a deformation state of a skeleton structure member according to the invention after the end of a bending test;

FIG. 10 is a graph showing a bending test on a skeleton structure member according to the invention;

FIG. 11A and FIG. 11B are perspective views showing an embodiment of a skeleton structure member according to the invention applied to a vehicle;

FIG. 12A to FIG. 12E are sectional views of an embodiment of a skeleton structure member according to the invention employed in a front side frame;

FIG. 13A to FIG. 13D are sectional views of an embodiment of a skeleton structure member according to the invention employed in a rear frame;

FIG. 14A to FIG. 14C are sectional views of an embodiment of a skeleton structure member according to the invention employed in a center pillar;

FIG. 15A to FIG. 15C are sectional views of an embodiment of a skeleton structure member according to the invention employed in a roof side rail;

FIG. 16 is a sectional view of a first solidified granular bulk material of a skeleton structure member of related art;

FIG. 17 is a sectional view of a second solidified granular bulk material of a skeleton structure-member of related art;

FIG. 18 is a view showing a method of a skeleton structure member bending test;

FIG. 19 is a graph showing a relationship between load and displacement in a bending test on a skeleton structure member;

FIG. 20A to FIG. 20D are graphs showing relationships between load and displacement, and absorbed energy, in a skeleton structure member bending test;

FIG. 21 is a view showing a deformation state of a skeleton structure member of related art in a bending test;

FIG. 22 is a graph showing relationships between load and displacement of skeleton structure members of Comparison Examples 1 to 3 in a bending test; and

FIG. 23 is a graph showing absorbed energies of Comparison Examples 1 to 3 in the bending test.

### BEST MODES OF CARRYING OUT THE INVENTION

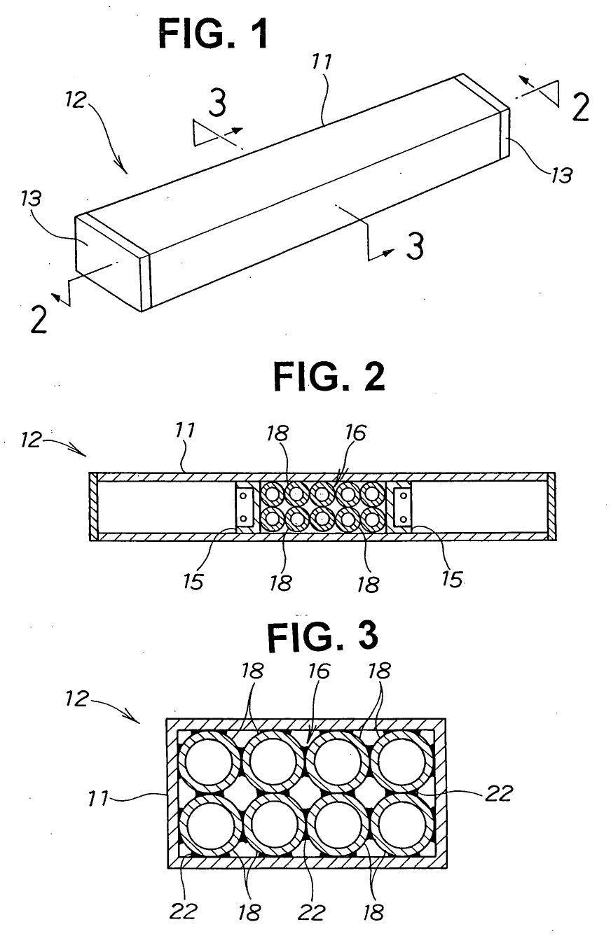

FIG. 1 shows a skeleton structure member 12 for use in a transport machine made by packing a solidified granular bulk material into a hollow skeleton member 11 (hereinafter simply written “the skeleton structure member 12”). The reference numbers 13, 13 denote end closing members for closing the ends of the skeleton member 11.

The skeleton structure member 12 shown in FIG. 2 is made by fitting partition wall members 15, 15 inside the skeleton member 11 and packing a solidified granular bulk material 16 into a space between these partition wall members 15, 15. Here, the solidified granular bulk material 16 is disposed in the length-direction center of the skeleton structure member 12. The reference number 18 denotes hollow granules, and although in practice their external diameter is 10 to 200am, in the figure, for the purpose of illustration, they have been drawn large (and similarly hereinafter).

FIG. 3 shows a solidified granular bulk material 16 made by bonding together granules 18, packed into a skeleton member 11 with a hollow square cross-section.

FIG. 4 shows granules 18, 18 bonded together by surface fusion by heating. The reference numbers 21, 21 denote cavities of the granules 18, 18, and the reference numbers 22, 22 denote solidified parts where the surfaces of the granules 18, 18 have fused and solidified.

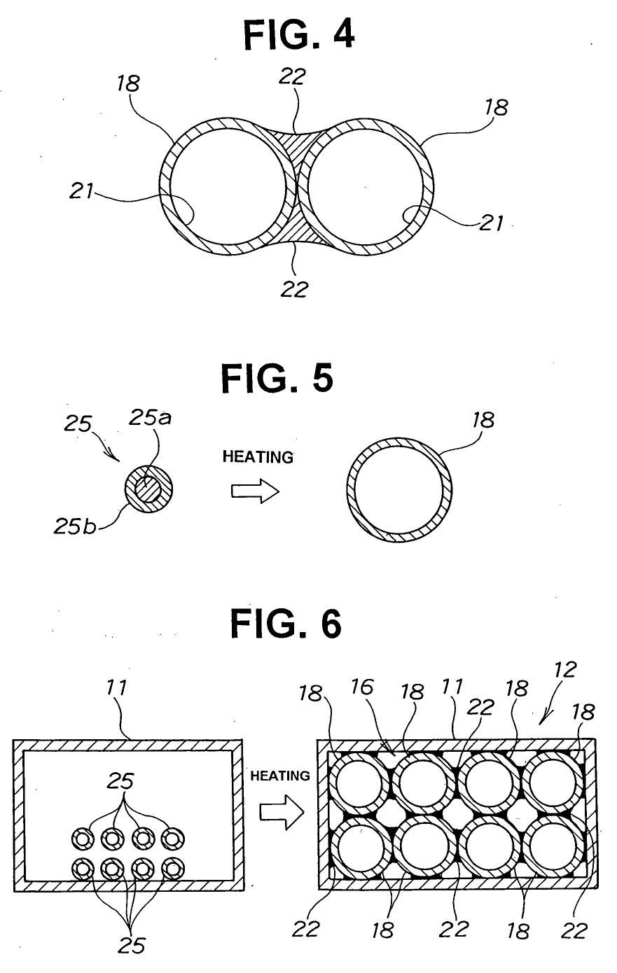

In FIG. 5, when a granule 25 is heated, it expands and one of the above-mentioned granules 18 is created.

The granules 25 are so-called ‘microcapsules’, made by atomizing a core substance (liquid or solid) 25a and covering this core substance 25a with a film 25b (that is, wrapping it with a shell), and when heated the core substance 25a gasifies and the film (that is, shell) 25b softens and expands to become a granule 18.

As the composition of the film (shell) 25b, a thermoplastic resin is suitable, that is, (1) acrylic acid, methacrylic acid, itaconic acid, citraconic acid, maleic acid, fumaric acid, vinyl benzoic acid, and esters of these acids, (2) nitrites such as acrylonitrile and methacrylonitrile, (3) vinyl compounds such as vinyl chloride and vinyl acetate, (4) vinylidine compounds such as vinylidine chloride, (5) vinyl aromatics such as styrene, (6) others such as ethylene glycol di (meth)acrylate, di ethylene glycol di (meth)acrylate, tri ethylene glycol di(meth)acrylate, neopentyl glycol (meth)acrylate, 1, 6 hexane diol di acrylate, 1, 9 nonane diol di (meth)acrylate, average molecular weight 200 to 600 polyethylene glycol di acrylate, average molecular weight 200 to 600 polyethylene glycol di methacrylate, tri methyl propane di (meth)acrylate, tri methyl propane tri (meth)acrylate, pentaerythritol tetra acrylate, di pentaerythritol acrylate, di pentaerythritol hexa acrylate, and polymers of these monomers and copolymers of combinations of them.

And, as the core substance 25a, low-boiling-point hydrocarbons such as ethane, propane, butane, isobutane, pentane, isopentane, hexane, isohexane, octane, isooctane, and chlorofluorocarbons are suitable.

FIG. 6 shows a manufacturing method for a skeleton structure member according to the invention.

First, a predetermined quantity of granules 25 is put in a skeleton member 11. Then, the skeleton member 11 and the granules 25 are heated. As a result, the granules 25 expand and fill the inside of the skeleton member 11 and the surfaces of the granules 25 fuse together, and, after cooling, the granules 18 are bonded together to form a solidified granular bulk material 16 and a skeleton structure member 12 is obtained.

For example, in a vehicle, if granules 25 are poured into a vehicle skeleton member and heated to 130 to 200° C. on a paint drying line provided in a production line for drying paint on the vehicle, a skeleton structure member is finished at approximately the same time as the completion of the paint drying. Accordingly, it is not necessary for a heating apparatus to be provided separately, and furthermore an extra time for heating the granules 25 is not necessary, and consequently it is possible to minimize cost increases and increases in manufacturing time.

The skeleton structure member 12 is a member in which the granules 18 are bonded to each other and the granules 18 and the inner faces of the skeleton member 11 are bonded together, and because at the time of expansion a pressure acts among the granules 25 and a pressure also acts on the skeleton member 11 from the granules 25, the bonding together of the granules 18 and the bonding of the granules 18 and the inner walls of the skeleton member 11 after the surface fusion is strong, and the rigidity and strength of the skeleton structure member 12 can be raised.

And, because as a result of the granules 25 being made of a thermoplastic resin they can be made to fuse at a low temperature, a special heating apparatus that produces a high temperature is not necessary.

Also, the above-mentioned pressure created inside the skeleton structure member 12 by the granules 18 can be altered through the quantity of granules 25 placed in the skeleton member 11, and by altering this internal pressure it is possible to determine the mechanical characteristics of the skeleton structure member 12.

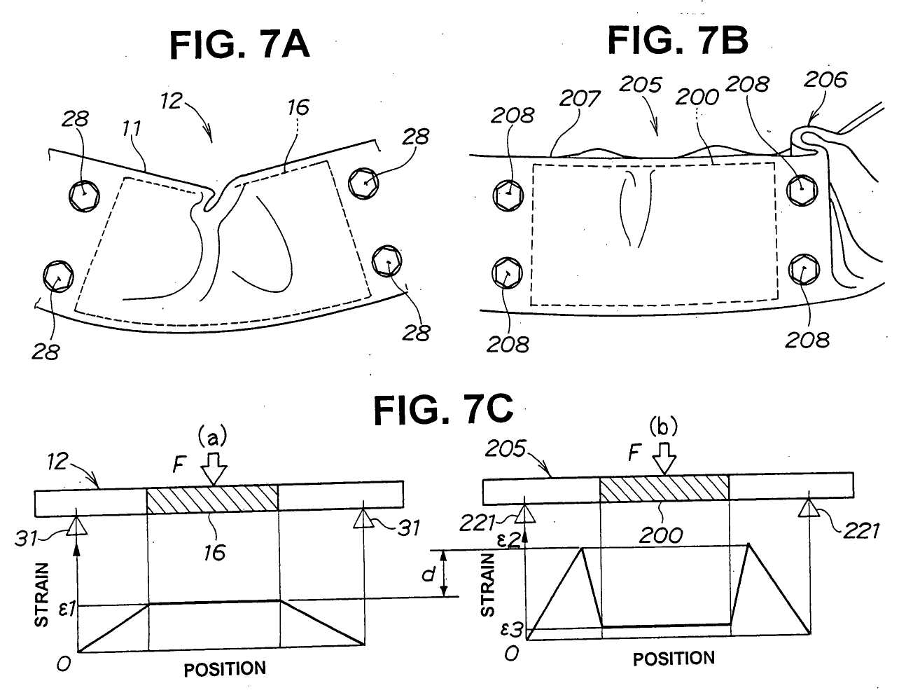

FIG. 7A shows a part of the skeleton structure member 12 packed with the solidified granular bulk material 16 (the dashed line in the figure) having deformed into an approximate arc shape. The reference number 28 denotes bolts fixing the partition wall members 15, 15 (see FIG. 2) to the skeleton member 11.

FIG. 7B shows a part of the skeleton structure member 205 packed with the solidified granular bulk material 200 (shown with a dashed line in the figure) having deformed very little and the skeleton member 207 on the outer sides of the solidified granular bulk material 200 having deformed greatly. The reference number 208 denotes bolts fixing partition wall members (not shown) for sandwiching the solidified granular bulk material 200 from both sides to the skeleton member 207.

FIG. 7C(a) shows in the form of a graph the strain arising between the support points 31, 31 of the skeleton structure member 12 when the skeleton structure member 12 drawn schematically is supported on two support points 31, 31 and a downward load F is applied to the upper face of the skeleton structure member 12 in a central position of the spacing between these support points 31, 31. The vertical axis shows strain and the horizontal axis shows position in the length direction of the skeleton structure member 12.

At the positions of the support points 31, 31 the strain is zero, and with progress from this position toward the solidified granular bulk material 16 (the part shown with hatching in the figure) the strain gradually increases, and at the position of the solidified granular bulk material 16 the strain is constant. The strain at this time will be written El.

FIG. 7C(b) shows in the form of a graph the strain arising between the support points 221, 221 of the skeleton structure member 205 when the skeleton structure member 205 drawn schematically is supported on two support points 221, 221 and a downward load F is applied to the upper face of the skeleton structure member 205 in a central position of the spacing between these support points 221, 221. The vertical axis shows strain and the horizontal axis shows position in the length direction of the skeleton structure member 205.

At the positions of the support points 221, 221 the strain is zero, and with progress from this position toward the solidified granular bulk material 200 the strain sharply increases, and the strain has maximums at outer positions near the ends of the solidified granular bulk material 200. The strain at this time will be written ε2.

From the positions where the strain is maximal to the ends of the solidified granular bulk material 200 the strain decreases, and at the position of the solidified granular bulk material 200 the strain becomes constant. The strain at this time will be written ε3.

In FIG. 7A, FIG. 7B, FIG. 7C(a) and FIG. 7C(b) above, in the case of the skeleton structure member 205 of the comparison example, whereas because the rigidity of the solidified granular bulk material 200 is excessively large the solidified granular bulk material 200 deforms hardly at all and the strain ε3 is small, the skeleton member 207 locally deforms greatly and the strain ε2 becomes very large. Consequently, in the early stage the load F falls greatly. That is, the absorbed energy is low.

With respect to this, in the skeleton structure member 12 of the embodiment, because the rigidity of the solidified granular bulk material 16 is low compared to that of the solidified granular bulk material 200 of the comparison example and in the bending test the solidified granular bulk material 16 deforms gradually and deforms almost uniformly, the maximum strain ε1 can be kept low with respect to the maximum strain ε2 in the comparison example. That is, the strain ε1 is lower than the strain ε2 by an amount d. Therefore, with the skeleton structure member 12 of the embodiment, in the bending test it is possible to maintain a high load up to a large displacement, and it is possible to increase the absorbed energy with respect to the comparison example.

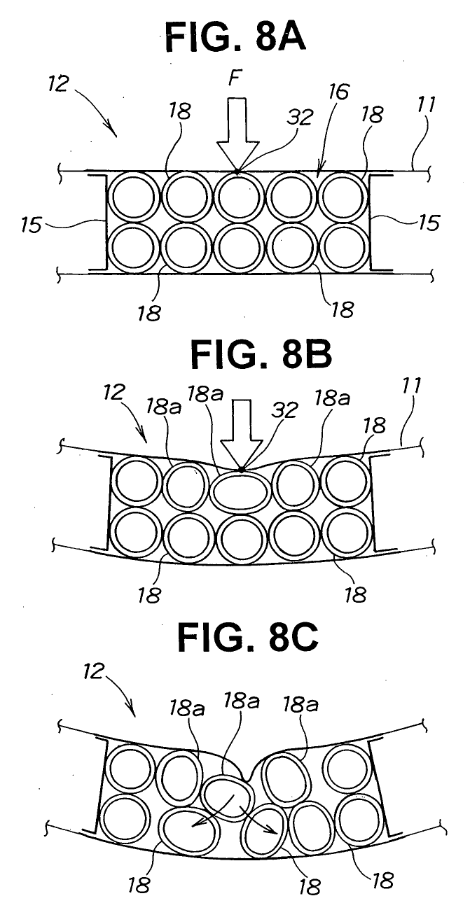

In FIG. 8A, a load F is applied to the skeleton structure member 12. 32 is a load application point on the skeleton member 11 where the load F is applied.

In FIG. 8B, the skeleton structure member 12 bends, and when the granules in the vicinity of the load application point 32 are called 18a, at these granules 18a . . . the solidified parts 22 (see FIG. 4) detach and the bonds between the granules 18a break and the granules 18a themselves deform (the deformation is greater the nearer to the load application point 32) and sharp increasing of the internal pressure of the skeleton member 11 is suppressed.

In FIG. 8C, when the bending of the skeleton structure member 12 increases further, detachment of the solidifying parts of the granules 18a and deformation of the granules 18a themselves proceeds, and the solidified granular bulk material 16 (see FIG. 8A) changes into multiple single granules and flows as shown with arrows and distributes the strain. Consequently, a large load can be maintained stably up to a large displacement.

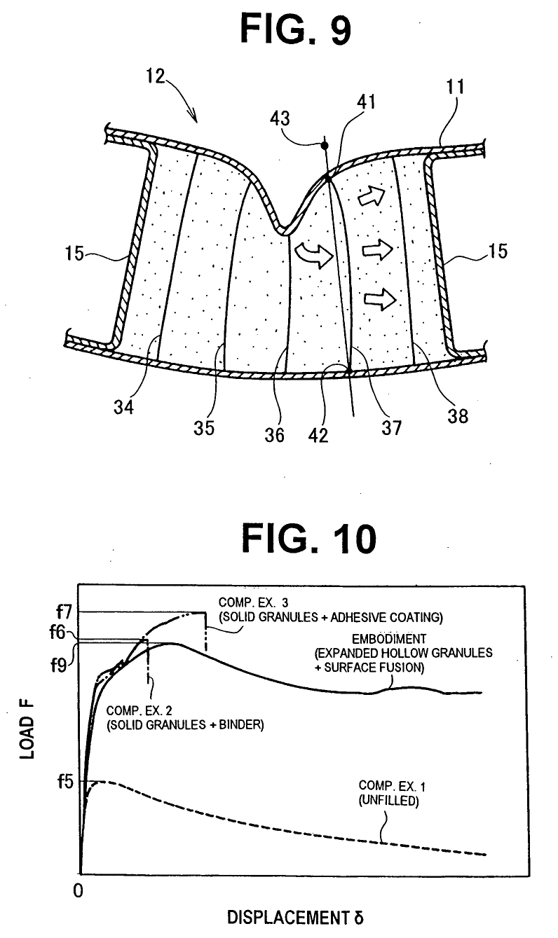

In FIG. 9, when changes of lines 34 to 38 drawn on the solidified granular bulk material as straight lines in a direction perpendicular to the length direction of the skeleton structure member 12 before the start of the bending test are observed, when after the bending test is finished for example the end points of the line 37, i.e. the points where it intersects with the skeleton member 11, are called the end points 41, 42 and a straight line 43 passing through these end points 41, 42 is drawn, it can be seen that the line straight line 37 has curved away from the straight line 43 toward the end of the skeleton structure member 12. That is, it can be seen that, as a result of the upper part of the skeleton member 11 deforming concavely, the above-mentioned granules whose surface fusion parts have detached and granules that have deformed have flowed toward one of the partition wall members 15, as shown with white arrows.

In the data of the skeleton structure member 12 of the embodiment (expanded hollow granules +surface fusion) shown in FIG. 10 (the one shown with a solid line), the rise angle, the length of the straight line part of that rise, and the maximum load f9 are substantially the same as in Comparison Example 2 and Comparison Example 3 discussed earlier, and in the rigidity and strength points there is no great difference. Also, a large load F is maintained up to a large displacement δ. Thus, with the skeleton structure member 12 of this invention, it is possible to increase the absorbed energy compared to Comparison Example 1 to Comparison Example 3.

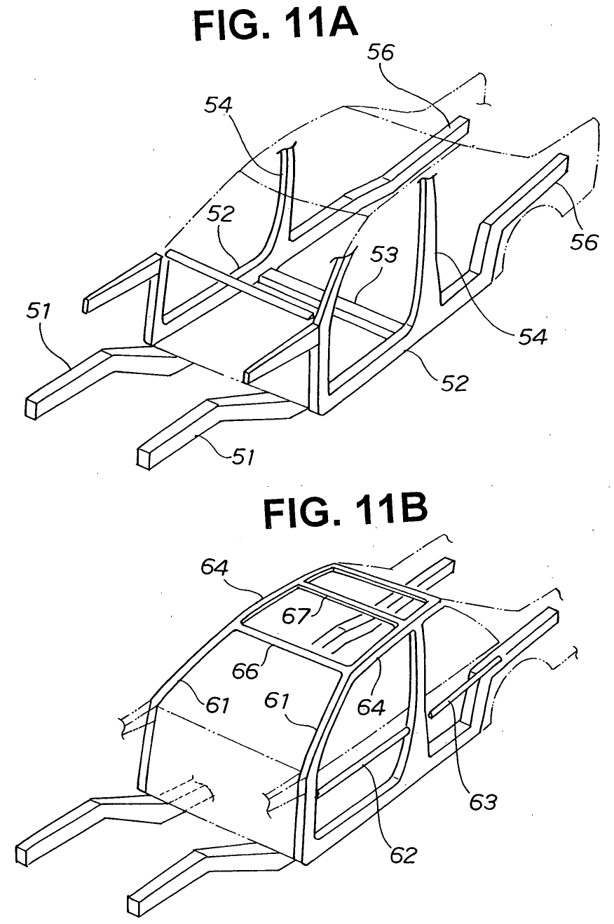

In FIG. 11A, skeleton structure members of the invention are employed in front side frames 51, 51 disposed below and to the sides of an engine at the front of a vehicle body; side sills 52, 52 disposed below and to the sides of a passenger compartment; a front floor cross member 53 extending between the left and right side sills 52, 52; center pillars 54, 54 rising from the side sills 52, 52; and rear frames 56, 56 extending rearward from the side sills 52, 52.

And in FIG. 11B, skeleton structure members of the invention are employed in front pillars 61, 61; door beams 62, 63 disposed inside a front door (not shown) and inside a rear door (not shown) respectively; roof side rails 64, 64 provided at the sides of a roof, and roof rails 66, 67 extending between the left and right roof side rails 64, 64.

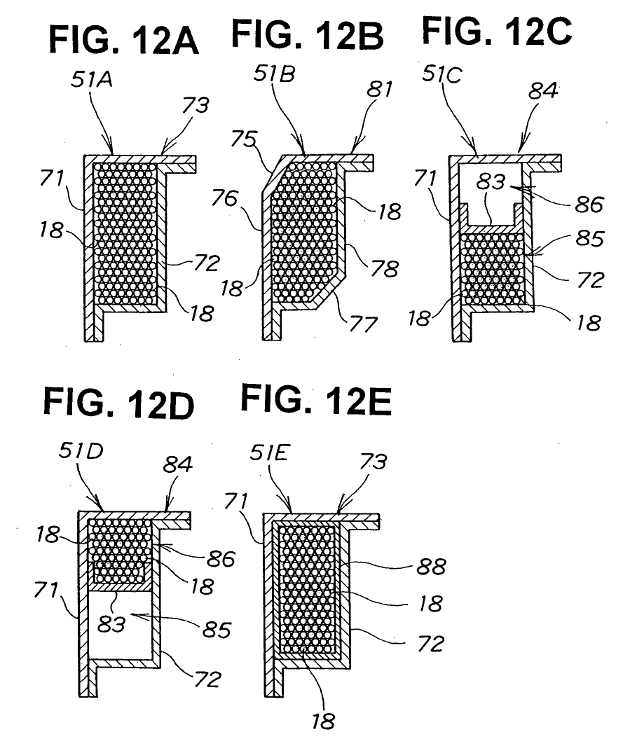

FIG. 12A to FIG. 12E show an embodiment of a skeleton structure member according to the invention employed in a front side frame. The reference number 51 of a front side frame 51 constituting a skeleton structure member has here for convenience been changed to 51A to 51E. In the front side frames 51A to 51D the granules 18 are packed into a skeleton member directly, and in the front side frame 51E the granules 18 are inserted into the skeleton member after having been pre-packed into another skeleton member.

The front side frame 51A shown in FIG. 12A is a member made by forming a skeleton member 73 from an outer panel 71 and an inner panel 72 provided on the engine compartment side of this outer panel 71, and filling the inside of this skeleton member 73 with granules 18. When the granules 18 are packed into the front side frame 51A they may be packed into the whole of the length direction of the front side frame 51A or packed partially in the length direction of the front side frame 51A. That is, two partition walls may be provided a predetermined spacing apart in the length direction inside the front side frame 51A, and the granules 18 packed between these two partition walls. This is the same also for the parts discussed below.

The front side frame 51B shown in FIG. 12B is a member made by forming a skeleton member 81 from an outer panel 76 provided with a slant face 75 and an inner panel 78 provided on the engine compartment side of this outer panel 76 and formed with a slant face 77, and filling this skeleton member 81 with granules 18.

The front side frame 51C shown in FIG. 12C is a member made by forming a skeleton member 84 from an outer panel 71 and an inner panel 72 and a partition wall 83 fitted on the inner sides of the outer panel 71 and the inner panel 72, and filling a first compartment 85, of a first compartment 85 and a second compartment 86 separated by the partition wall 83 inside the outer panel 71 and the inner panel 72, with granules 18.

The front side frame 51D shown in FIG. 12D is a member made by filling the second compartment 86 of the front side frame 51C shown in FIG. 12C with granules 18.

The front side frame 51E shown in FIG. 12E is a member made by filling a skeleton member 88 with granules 18 and disposing this skeleton member 88 on the inner side of a skeleton member 73.

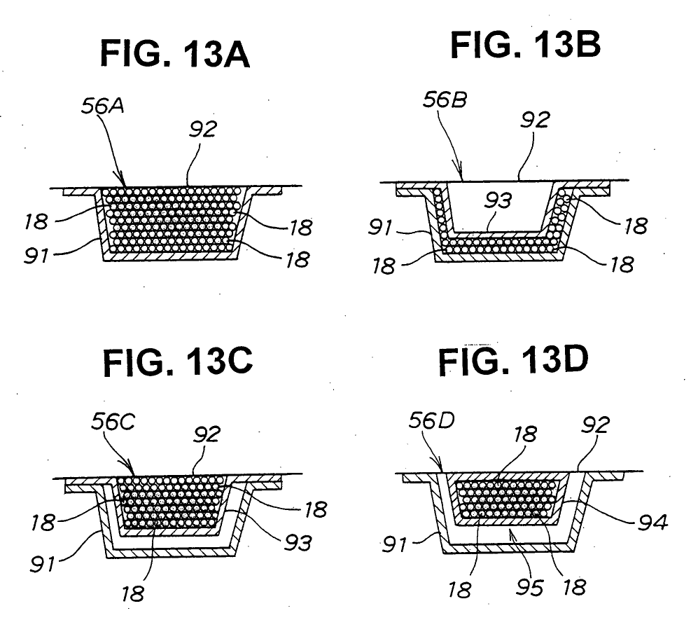

FIG. 13A to FIG. 13D show embodiments of a skeleton structure member according to the invention applied to a rear frame. The reference number 56 of a rear frame 56 constituting a skeleton structure member has for convenience here been changed to 56A to 56D.

The rear frame 56A shown in FIG. 13A is a member made by packing granules 18 between a lower panel 91 constituting a panel member and a rear floor panel 92 constituting a panel member provided above this lower panel 91.

The rear frame 56B shown in FIG. 13B is a member made by packing granules 18 between a lower panel 91 and a sub lower panel 93 fitted above the lower panel 91.

The rear frame 56C shown in FIG. 13C is a member made by packing granules 18 between a sub lower panel 93 fitted above the lower panel 91 and a rear floor panel 92 provided above this sub lower panel 93.

The rear frame 56D shown in FIG. 13D is a member made by disposing a skeleton member 94 in a closed space bounded by a lower panel 91 and a rear floor panel 92 and packing this skeleton member 94 with granules 18.

Alternatively, instead of granules 18 being packed inside the skeleton member 94, granules 18 may be packed in a space 95 bounded by the skeleton member 94 and the lower panel 91 and the rear floor panel 92 as panel members peripheral thereto, or both the skeleton member 94 and the space 95 may be filled with granules 18.

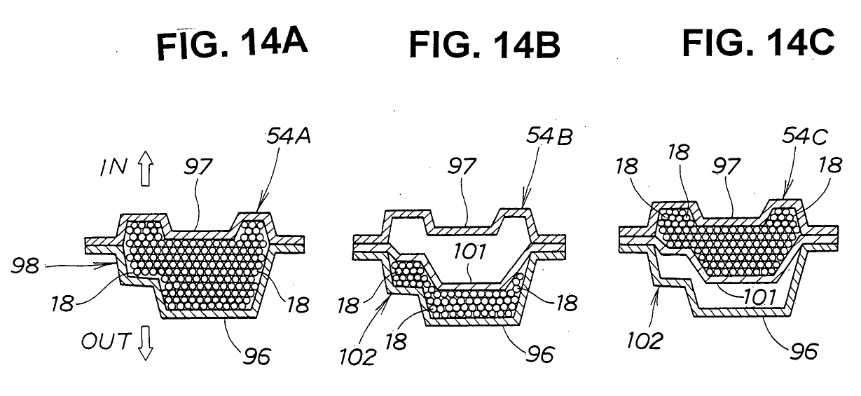

FIG. 14A to FIG. 14C show embodiments of a skeleton structure member according to the invention employed in a center pillar. The reference number 54 of the center pillar 54 constituting a skeleton structure member has here for convenience been changed to 54A to 54C.

The center pillar 54A shown in FIG. 14A is a member made by forming a skeleton member 98 with an outer panel 96 and an inner panel 97 disposed on the passenger compartment side of the outer panel 96, and filling this skeleton member 98 with granules 18.

The center pillar 54B shown in FIG. 14B is a member made by forming a skeleton member 102 by fitting a reinforcing member 101 between an outer panel 96 and an inner panel 97 and packing granules 18 between the reinforcing member 101 and the outer panel 96.

The center pillar 54C shown in FIG. 14C is a member made by fitting a reinforcing member 101 between an outer panel 96 and an inner panel 97 and packing granules 18 between the reinforcing member 101 and the inner panel 97.

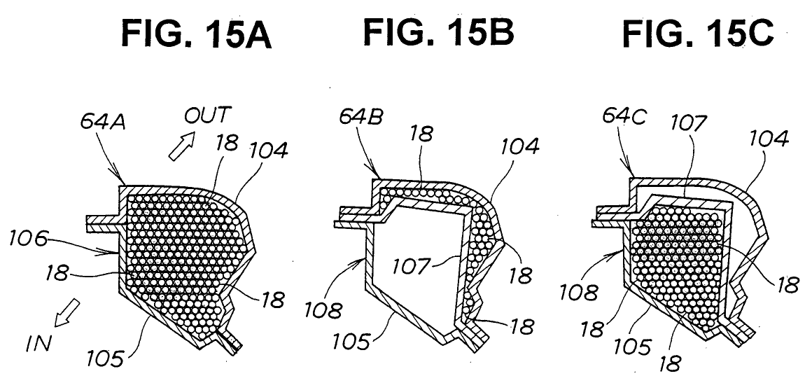

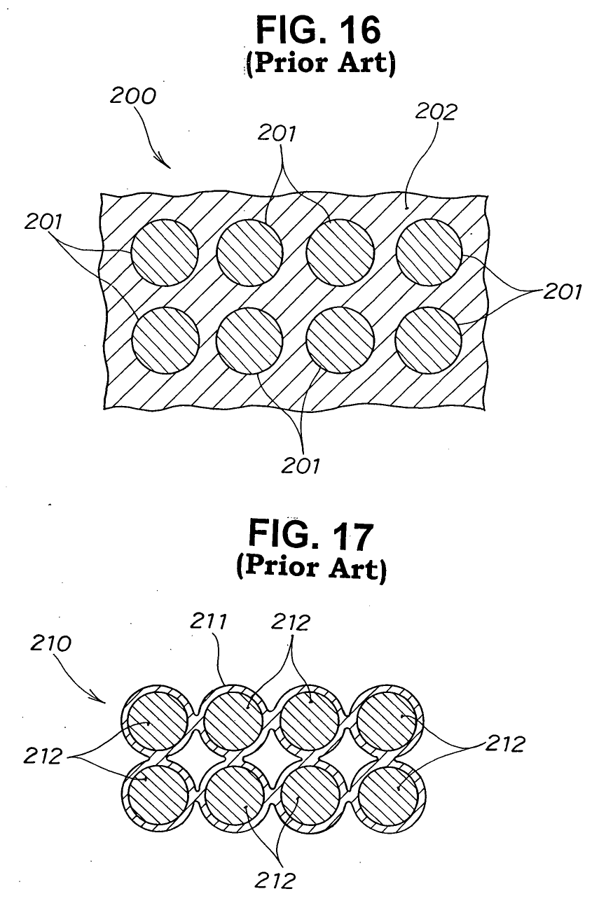

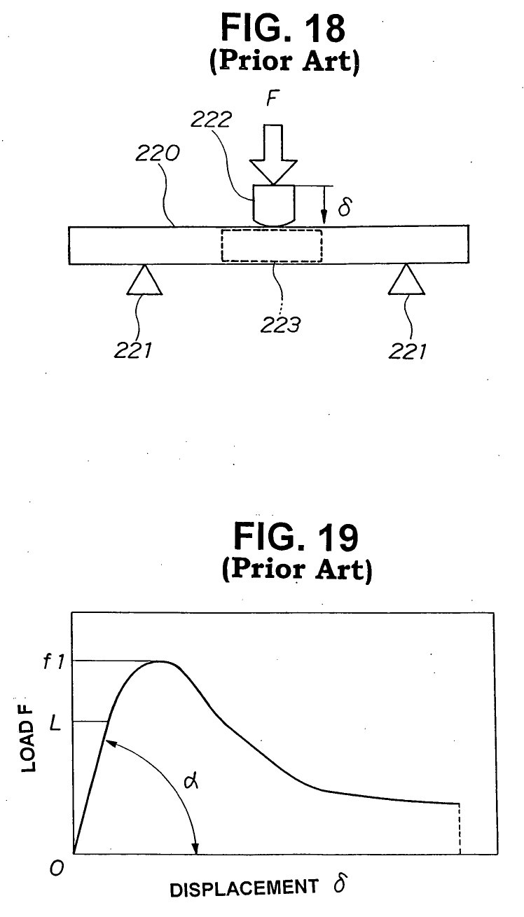

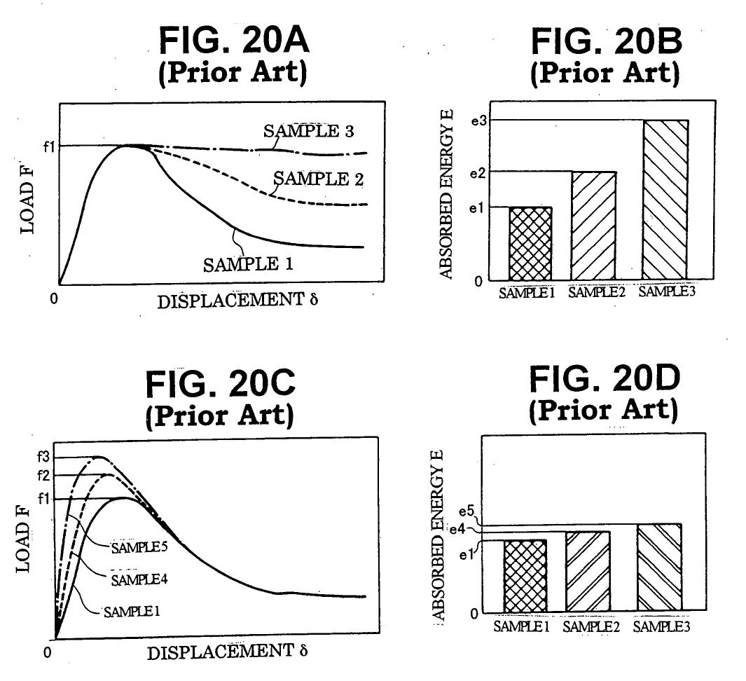

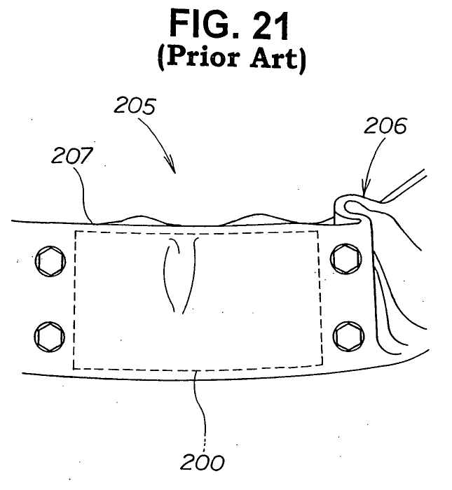

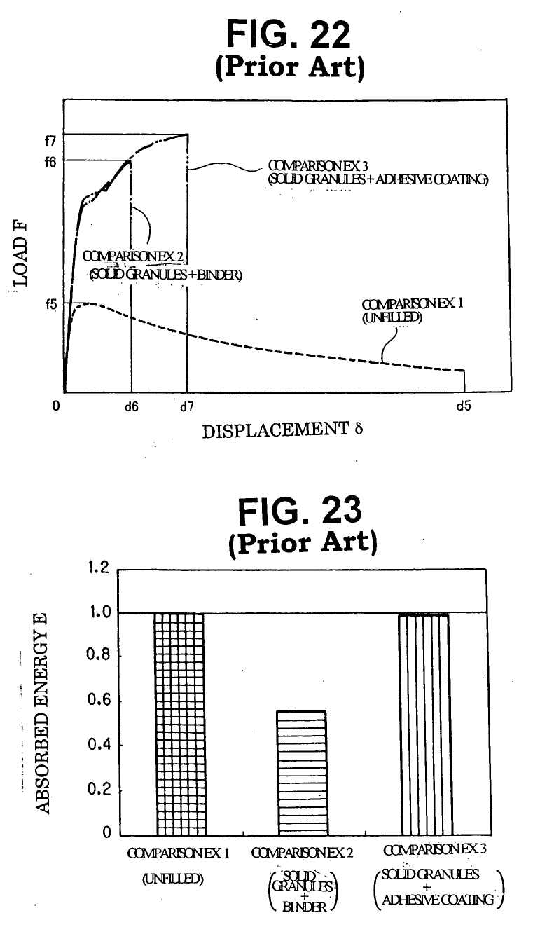

FIG. 15A to FIG. 15C show embodiments of a skeleton structure member according to the invention employed in a roof side rail. The reference number of a roof side rail 64 has here for convenience been changed to 64A to 64C.

The roof side rail 64A shown in FIG. 15A is a member made by forming a skeleton member 106 with an outer panel 104 and an inner panel 105 disposed on the passenger compartment side of this outer panel 104, and filling this skeleton member 106 with granules 18.

The roof side rail 64B shown in FIG. 15B is a member made by forming a skeleton member 108 by fitting a reinforcing member 107 between an outer panel 104 and an inner panel 105 and packing granules 18 between the reinforcing member 107 and the outer panel 104.

The roof side rail 64C shown in FIG. 15C is a member made by forming a skeleton member 108 by fitting a reinforcing member 107 between an outer panel 104 and an inner panel 105 and packing granules 18 between the reinforcing member 107 and the inner panel 105.

As explained with reference to FIG. 2 to FIG. 4, the present invention is a skeleton structure member 12 made by disposing a solidified granular bulk material 16 solidified by bonding together and thereby solidifying multiple granules 18 inside a skeleton member 11 of a transport machine and/or a space (for example the space 95 shown in FIG. 13D) bounded by a skeleton member 11 and a panel member peripheral thereto (for example the lower panel 91 and the rear floor panel 92 shown in FIG. 13D), characterized in that the granules 18 are bonded together by surface fusion and an internal pressure is created by expansion.

Because the granules 18 are bonded together by surface fusion, an adhesive or resin binder for bonding the granules 18 together is not needed, and weight increase accompanying solidification can be kept down.

And, because an internal pressure is created by expansion of the granules 18, packing under pressure is not necessary and it is possible to fill a skeleton member or a space (for example the space 95) with granules 18 easily.

Also, when a load acts on the solidified granular bulk material 16 from outside, the granules 18 that had been solidified undergo detachment of their superficial fused parts and become single granules or small pieces of solid and come to have fluidity, and strain arising as a result of the load from outside is distributed and concentration of the strain can be prevented.

Accordingly, it is possible to make the skeleton structure member 12 deform substantially uniformly and up to a large displacement. At this time, because by means of the above-mentioned internal pressure it is possible to suppress inward deformation of the skeleton member wall, a large load can be supported up to a large displacement, and compared with related art it is possible to increase the absorbed energy of the skeleton structure member 12.

And, as explained with reference to FIG. 5 and FIG. 6, the invention is a manufacturing method of a skeleton structure member 12 made by disposing a solidified granular bulk material 16 solidified by bonding together and thereby solidifying multiple granules 18 inside a skeleton member 11 of a transport machine and/or a space (for example the space 95 shown in FIG. 13D) bounded by a skeleton member 11 and a panel member peripheral thereto (for example the lower panel 91 and the rear floor panel 92 shown in FIG. 13D), characterized in that it includes a step of placing granules 25 made by wrapping a core substance 25a consisting of a liquid or a solid with a film 25b into a skeleton member 11 or a space (for example the space 95) in an un-expanded state and a step of causing the granules 25 to expand by heating them.

If the core substance 25a is gasified by the granules 25 being heated and expanded, the granules 18 constituting the solidified granular bulk material 16 become hollow, and it is possible to suppress weight increase accompanying solidification and reduce the weight of the skeleton structure member 12.

And, because as a result of the granules 25 expanding an internal pressure is created in the skeleton member 11 or the space, packing under pressure is not necessary and it is possible to fill the inside of the skeleton member 11 or the inside of the space with granules 18 easily. Accordingly, it is possible to increase the manufacturability of the skeleton structure member 12.

Also, when a load acts on the solidified granular bulk material 16 from outside, more so than when solid granules are used, the strength of the solidified granular bulk material 16 does not become excessively large, and furthermore under the load acting from outside the granules 18 constituting the solidified granular bulk material 16 come to flow while deforming gradually, and strain arising as a result of the load from outside is distributed and concentration of the strain can be prevented. Accordingly, the strength of the solidified granular bulk material 16 does not change suddenly, a large load can be supported up to a large displacement, and compared to related art it is possible to increase the absorbed energy of the skeleton structure member 12.

Although in the embodiments of the invention the granules were placed into the skeleton member directly, there is no limitation to this, and alternatively they may be pre-packed into a bag (made of rubber, a resin such as polyurethane, or paper) or a vessel before being placed in the skeleton member.

### INDUSTRIAL APPLICABILITY

As described above, with the skeleton structure member and manufacturing method thereof set forth above it is possible to suppress weight increase and pack granules into a skeleton member easily, and the absorbed energy of the skeleton structure member is increased; consequently, it is suited for use in various transport machines.

1. A skeleton structure member made by disposing a solidified granular bulk material obtained by bonding together and thereby solidifying multiple granules inside a skeleton member of a transport machine and/or a space bounded by the skeleton member and a panel member peripheral thereto,
wherein, in the solidified granular bulk material, the granules are bonded together by surface fusion and an internal pressure is created by expansion.

2. A method for manufacturing a skeleton structure member made by disposing a solidified granular bulk material obtained by bonding together and thereby solidifying multiple granules inside a skeleton member of a transport machine and/or a space bounded by the skeleton member and a panel member peripheral thereto,
said method including the steps of placing granules, which are made by wrapping a core substance consisting of a liquid or a solid with a film, into the skeleton member and/or space in an unexpanded state, and,
heating the granules and thereby causing the granules to expand.
